(19) United States
(12) Patent Application Publication
(10) Pub. No.: US 2015/0015018 A1
(43) Pub. Date: Jan. 15, 2015

(54) OPENING/CLOSING DEVICE FOR LOAD BOX GATE ON FREIGHT VEHICLE

(71) Applicant: Soon Chae Lee, Incheon (KR)

(72) Inventor: Soon Chae Lee, Incheon (KR)

(21) Appl. No.: 14/374,513

(22) PCT Filed: Jan. 25, 2013
(86) PCT No.: PCT/KR2013/000606

§ 371 Date: Jul. 24, 2014

(30) Foreign Application Priority Data
Jan. 25, 2012 (KR) 10-2012-0007326

(51) Int. Cl. B62D 33/037; B60P 1/00; B62D 33/03

(52) U.S. Cl. CPC B62D 33/037; B62D 33/03; B60P 1/003
USPC 296/36

(57) ABSTRACT

The present invention relates to an opening/closing device for a load box gate on a freight vehicle, and the opening/closing device comprises: the load box defined by a front gate, a rear gate, and side gates on both sides with a bottom surface at the center, a front connection member for connecting the front gate and the side gates, and a rear connection member for connecting the rear gate and the side gates. According to the present invention, operation of opening or binding the rear gate or the side gates can be automated, and random release of the rear gate or the side gates can be prevented.

### TECHNICAL FIELD

The present invention relates to a device for opening and closing a load box gate of a freight vehicle, and more particularly, to a device for opening and closing a gate with which it is possible to easily connect and separate a front gate, rear gate and side gate of a load box and it is possible to firmly fasten the gates.

### BACKGROUND ART

In general, gates that open or close a load box in various directions to allow freight to be easily loaded and to prevent the loaded freight from falling from the load box during traveling are fastened to a freight vehicle for transporting freight by hinges.

A top of the load box of the freight vehicle is opened, and when the freight is loaded or unloaded, a rear gate or/and a side gate are opened to perform an operation.

### DISCLOSURE

### Technical Problem

As mentioned above, there is a problem that since an operation for opening or restraining the rear gate or/and the side gate is manually performed in order to load or unload the freight, the operation is inconvenient. Further, there is a problem that the restrained portion is highly likely to be separated by vibration caused during traveling.

In order to solve the problem, an object of the present invention is to provide a device for opening and closing a load box gate of a freight vehicle with which it is possible to automatically perform an operation for opening or restraining the rear gate or the side gate and it is possible to prevent the rear gate or the side gate from being separated by external force by firmly restraining the gates.

### Technical Solution

In order to achieve the above object, according to one aspect of the present invention, there is provided a device for opening and closing a load box gate of a freight vehicle including a load box which includes a front gate and a rear gate which are respectively attached to front and rear sides with a bottom surface as its center, and a side gate provided on both sides.

The device for opening and closing a gate includes a front connecting member which connects the front gate to the side gate; and a rear connecting member which connects the rear gate to the side gate. The front connecting member includes a front settling groove which is formed on a side surface of the front gate; a front protruding piece which is fixed to protrude from the side gate and settles into the front settling groove; and a front restraining means which restrains or releases the front protruding piece settling into the front settling groove.

The rear connecting member includes a rear settling groove which is formed at the side gate; a rear protruding piece which is fixed to protrude from the rear gate and settles into the rear settling groove; and a rear restraining means which restrains or releases the rear protruding piece settling into the rear settling groove.

In the present invention, the front restraining means may include a forward and reverse motor; a front elevating plate that is elevated up and down by driving of the forward and reverse motor, and restrains the front protruding piece settling into the front settling groove; a front close button that raises the front elevating plate; and a front open button that lowers the front elevating plate.

Further, a front operation button that comes in contact with the front protruding piece to raise the front elevating plate may be further attached to the front settling groove.

In the present invention, the rear restraining means may include a forward and reverse motor; a rear elevating plate that is elevated up and down by driving of the forward and reverse motor and restrains the rear protruding piece settling into the rear settling groove; a rear close button that raises the rear elevating plate; and a rear open button that lowers the rear elevating plate.

Furthermore, a rear operation button that comes in contact with the rear protruding piece to raise the rear elevating plate may be further attached to the rear settling groove.

According to another aspect of the present invention, the rear protruding piece may have a shape in which a part of a front end is bent.

### Effect of the Invention

In such a configuration of the present invention, it is possible to automatically perform an operation for opening or restraining the rear gate or the side gate by the front operation button and the rear operation button, and particularly, since the rear gate and the side gate are firmly restrained by the front protruding piece and the rear protruding piece, it is possible to prevent the rear gate or the side gate from being arbitrarily separated by external force.

### DESCRIPTION OF DRAWINGS

FIG. 1 is a side view of a freight vehicle to which a device for opening and closing a load box gate according to an embodiment of the present invention is attached.

FIGS. 2A and 2B are diagrams for describing a front connecting member shown in FIG. 1 when viewed from the front.

FIGS. 3A and 3B are diagrams for describing the front connecting member attached to a right side of the freight vehicle.

FIGS. 4A and 4B are diagrams for describing an operation of the front connecting member shown in FIG. 1.

FIG. 5A and 5B are diagrams for describing a rear connecting member shown in FIG. 1.

[Description of Main Reference Numerals of Drawings]

| | |
|---|---|
| 2110: Freight vehicle | 3: Front gate |
| 5: Side gate | 7: Rear gate |
| 10: Front connecting member | 11: Front settling groove |
| 12: Front protruding piece | 13: Front elevating plate |
| 14: Front close button | 15: Front open button |
| 16: Front operation button | 20: Rear connecting member |
| 21: Rear settling groove | 22: Rear protruding piece |
| 23: Rear elevating plate | 24: Rear close button |
| 25: Front open button | 26: Front operation button |

30a, 30b: Forward and reverse motor

### BEST MODE

Hereinafter, a preferred embodiment of the present invention will be described in detail with reference to the accompanying drawings, and throughout the drawings, the same reference numerals will denote the same parts.

FIG. 1 is a side view of a freight vehicle to which a device for opening and closing a load box gate according to an embodiment of the present invention is attached. As shown in the drawing, a gate connecting device according to the present invention includes a front connecting member 10 and a rear connecting member 20.

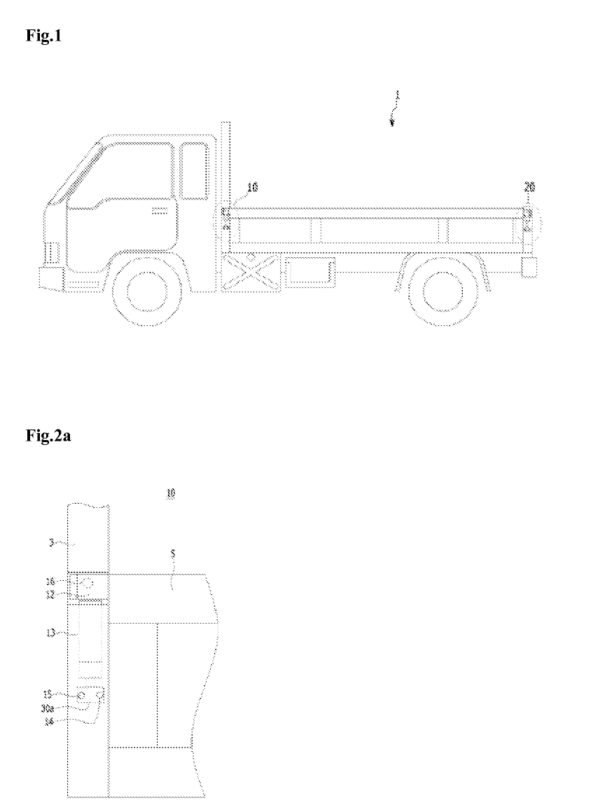

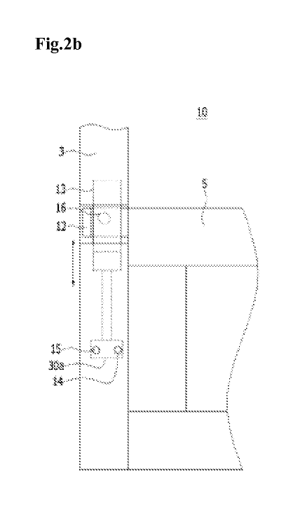

The front connecting member 10 will be described with reference to FIGS. 2A and 2B. FIGS. 2A and 2B are diagrams for describing the front connecting member 10 shown in FIG. 1 when viewed from the front.

As shown in the drawings, the front connecting member 10 includes a front settling groove 11 that is formed on a side surface of the front gate 3, a front protruding piece 12 that is fixed to protrude from the side gate 5 and settles into the front settling groove 11, and a front restraining means that restrains or releases the front protruding piece 12 settling into the front settling groove 11.

Further, a forward and reverse motor 30a that can be rotated in a forward direction and a reverse direction is attached to the front restraining means. A front elevating plate 13 that is elevated up and down by driving of the forward and reverse motor 30a and restrains the front protruding piece 12 settling into the front settling groove 11 is provided.

The front elevating plate 13 is elevated up by a front operation button 16 and a front close button 14 to be described below, and as shown in the drawings, the front operation button 16 is exposed to the outside so as to be manipulated by a user, and the front operation button 16 is attached to the front settling groove 11.

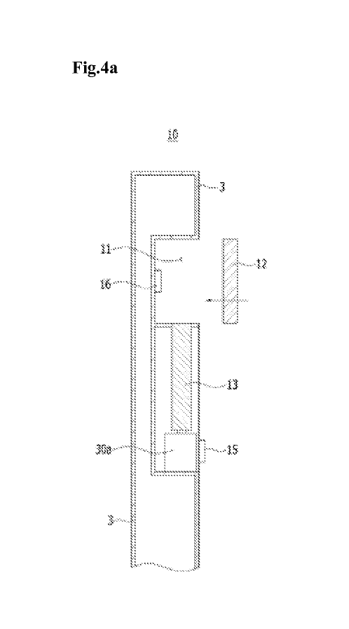

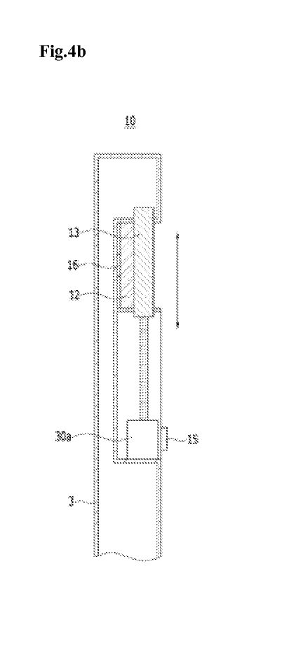

Accordingly, when the side gate 5 is restrained by the front gate 3, the front protruding piece 12 settles into the front settling groove 11. At this time, the front protruding piece 12 presses the front operation button 16 to operate the front operation button, and the forward and reverse motor 30a is operated by the operation of the front operation button 16 to raise the front elevating plate 13. Thus, the front protruding piece 12 is restrained (see FIGS. 4A and 4B).

As stated above, when the user presses the front open button 15 while the front protruding piece 12 settles into the front settling groove 11 to restrain the side gate 5, the forward and reverse motor 30a is reversely rotated to lower the front elevating plate 13, and the front protruding piece 12 is separated from the front settling groove 11 to release the side gate 5 from the front gate 3.

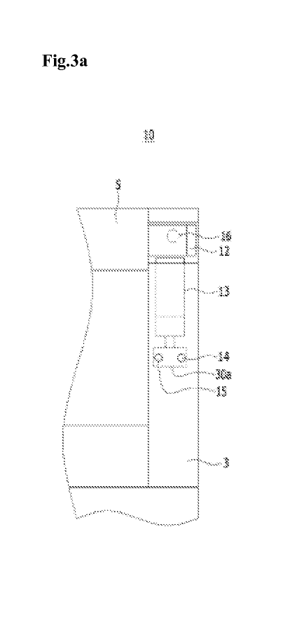

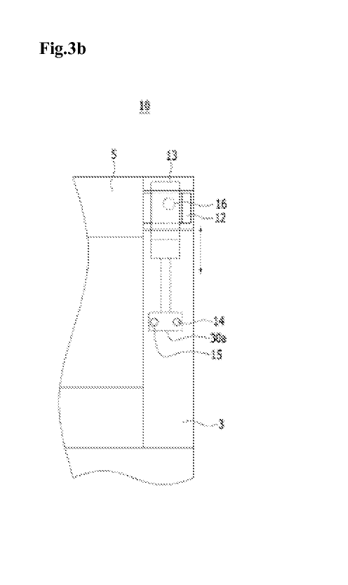

Furthermore, FIGS. 3A and 3B are diagrams for describing the front connecting member 10 attached to a right side of the freight vehicle, and since configurations and operations of FIGS. 3A and 3B are the same as those of FIGS. 2A and 2B, description thereof is not presented.

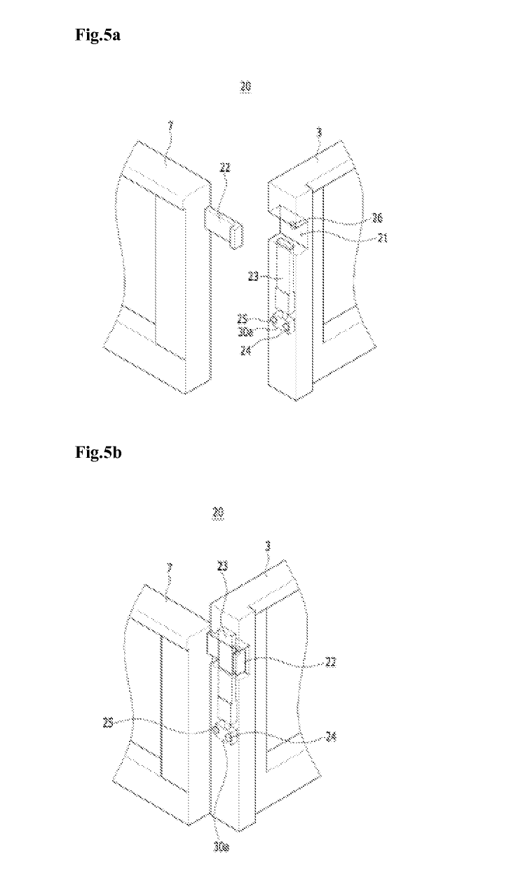

The rear connecting member 20 is illustrated in FIGS. 5A and 5B, and the rear connecting member 20 restrains or releases the side gate 5 and the rear gate 7.

The rear connecting member 20 includes a rear settling groove 21 formed at the side gate 5, a rear protruding piece 22 that is fixed to protrude from the rear gate 7 and settles into the rear settling groove 21, and a rear restraining means that restrains or releases and the rear protruding piece 22 settling into the rear settling groove 21.

Moreover, the rear restraining means includes a forward and reverse motor 30b, a rear elevating plate 23 that is elevated up and down by driving of the forward and reverse motor 30b, and restrains the rear protruding piece 22 settling into the rear settling groove 21, a rear close button 24 that raises the rear elevating plate 23, and a rear open button 25 that lowers the rear elevating plate 23.

The configurations of the rear connecting member 20 and the front connecting member 10 are similar to each other, but the front connecting member 10 connects the side gate 5 to the fixed front gate 3. However, since the rear connecting member 20 is connected to a frame on the bottom by a hinge, the rear gate 7 and the side gate that are rotated are connected to each other, so that a shape of the rear protruding piece 22 is different from that of the front protruding piece 12.

That is, as shown in FIG. 5A, the rear protruding piece 22 has a shape in which a front end is bent. Due to such a shape, the rear gate 7 and the side gate 5 are firmly connected to be fixed.

The aforementioned description is merely presented to implement the device for opening and closing a load box of a freight vehicle according to the present invention, and the present invention is not limited to the embodiment. It is appreciated to those skilled in the art that various modifications are possible and would fall within the technical spirit of the present invention without departing the gist of the present invention as claimed in the appended claims.

### INDUSTRIAL APPLICABILITY

The present invention relates to a device for opening and closing a load box gate of a freight vehicle, and since a front gate, rear gate and side gate of a load box are easily connected to each other and separated from each other to be firmly fastened, the device for opening and closing is usefully used in the industrial field.

1. A device for opening and closing a load box gate of a freight vehicle including a load box which includes a front gate (3) and a rear gate (7) which are respectively attached to front and rear sides with a bottom surface as its center, and a side gate (5) provided on both sides, the device comprising:
a front connecting member (10) which connects the front gate (3) to the side gate (5); and
a rear connecting member (20) which connects the rear gate (7) to the side gate (5),
wherein the front connecting member (10) includes:
a front settling groove (11) which is formed on a side surface of the front gate (3);
a front protruding piece (12) which is fixed to protrude from the side gate (5) and settles into the front settling groove (11); and
a front restraining means which restrains or releases the front protruding piece (12) settling into the front settling groove (11), and
wherein the rear connecting member (20) includes:
a rear settling groove (21) which is formed at the side gate (5);
a rear protruding piece (22) which is fixed to protrude from the rear gate (7) and settles into the rear settling groove (21); and
a rear restraining means which restrains or releases the rear protruding piece (22) settling into the rear settling groove (21).

2. The device for opening and closing a load box gate of a freight vehicle of claim 1,
wherein the front restraining means includes:
a forward and reverse motor (30a);
a front elevating plate (13) that is elevated up and down by driving of the forward and reverse motor (30a), and restrains the front protruding piece (12) settling into the front settling groove (11);
a front close button (14) that raises the front elevating plate (13); and
a front open button (15) that lowers the front elevating plate (13).

3. The device for opening and closing a load box gate of a freight vehicle of claim 2, wherein a front operation button (16) that comes in contact with the front protruding piece (12) to raise the front elevating plate (13) is further attached to the front settling groove (11).

4. The device for opening and closing a load box gate of a freight vehicle of claim 1, wherein the rear restraining means includes:
a forward and reverse motor (30b);
a rear elevating plate (23) that is elevated up and down by driving of the forward and reverse motor (30b) and restrains the rear protruding piece (22) settling into the rear settling groove (21);
a rear close button (24) that raises the rear elevating plate (23); and
a rear open button (25) that lowers the rear elevating plate (23).

5. The device for opening and closing a load box gate of a freight vehicle of claim 4, wherein a rear operation button (26) that comes in contact with the rear protruding piece (22) to raise the rear elevating plate (23) is further attached to the rear settling groove (21).

6. The device for opening and closing a load box gate of a freight vehicle of claim 4, wherein the rear protruding piece (22) has a shape in which a part of a front end is bent.
